(19) United States
(12) Patent Application Publication
(10) Pub. No.: US 2010/0205648 A1
(43) Pub. Date: Aug. 12, 2010

(54) Secure Integrated Media Center

(76) Inventors: Abbas Sasan Saadat, Ile-Perrot (CA); Lorne M. Trottier, Beaconsfield (CA)

Correspondence Address: SOMMER BARNARD ATTORNEYS, P.C., Suite 3500, One Indiana Square, Indianapolis, IN, 46204, US

(21) Appl. No.: 12/764,438

(22) Filed: Apr. 21, 2010

Related U.S. Application Data
(62) Division of application No. 11/008,401, filed on Dec. 9, 2004, now abandoned.
(60) Provisional application No. 60/527,747, filed on Dec. 9, 2003.

(51) Int. Cl. H04N 7/16; G06F 12/14; H04L 9/32; H04L 9/06

(52) U.S. Cl. 725/153; 713/189; 713/168; 380/44

(57) ABSTRACT

A set-top media system is disclosed which can be combined with an open architecture personal computer (PC) to provide a feature-rich secure integrated media center while meeting security rules of most major conditional access and content protection industry rules such as Cable Labs DFAST and PHILA agreements; and DTLA agreements for 5C-DTCP for IEEE1394, USB, and IP. The set-top media center and PC share common resources such as high definition display, remote control, hard disk drive, and other external unsecure storage devices. All media content is available seamlessly using a PC user interface, including controlled-content media such as high definition TV, within a PC desktop window. All controlled-content media is manipulated and managed within the set-top media system in a seamless manner. A mechanism is disclosed to allow controlled-content media to be stored on unsecure devices in encrypted form while overcoming the disk cloning attack problem for move operations. One embodiment utilizes a “grey list” of available programs to keep track of controlled-content media which is allowed to be played, while another embodiment utilizes a “black list” of programs no longer available to keep track of controlled-content media which is forbidden from being played.

### CROSS-REFERENCE TO RELATED APPLICATIONS

This application claims priority from U.S. provisional patent application No. 60/527,747, filed Dec. 9, 2003, which is incorporated herein by reference in its entirety.

### MICROFICHE APPENDIX

Not Applicable.

### TECHNICAL FIELD

The present invention relates to video and television set-tops or receiver systems and more particularly, to a secure integrated media center for handling controlled content.

### BACKGROUND OF THE INVENTION

Video cable and satellite receivers are commonly referred to as “set-top boxes” or “set-tops” because of their typical form factor of a compact box which can be placed on top of or near to a television. Throughout this document, including the claims, the term “set-top” will be understood to mean a video or media receiver, regardless of the form factor, size or shape of the device.

These set-tops house circuitry to decode digital satellite or cable signals, including high definition (HD) digital television which can not be received directly by most common televisions. With the advent of high definition (HD) digital television, and the potential to make limitless high quality digital copies, media content providers are increasingly looking for ways to prevent or restrict unauthorized copying of media content. Set-top boxes can be designed as closed systems which can be used to handle controlled-content media while preventing unauthorized access to the decoded digital video signal.

Integrated media center systems integrate various media functions such as television, video, photo and audio playback and recording as well as personal computer (PC) functions. The current state-of-the-art in media center systems is embodied in existing commercially available systems such as the HP Media Center m370n PC system sold with Microsoft Windows XP Media Center Edition 2004 software. These systems include analog TV tuners for receiving over the air and/or cable TV channels. The systems include a user friendly graphical user interface (GUI) supporting functions such as My TV which selects the current TV channel and which also includes an electronic program guide (EPG) and personal video recorder (PVR); My Music for managing and playing digital music libraries; My Pictures for managing and displaying digital photo collections; My Videos for organizing and playing recorded video content; Play DVD for playing DVD movies; and Create DVD for creating DVDs from recorded video. These systems are based on open architecture PCs and can handle regular PC functions as well, such as Web browsing, word processing, etc.

Digital set-top boxes or receivers are used for receiving and decoding digital television broadcasts from satellite, cable or terrestrial services. The current state-of-the-art in digital set-top boxes is embodied in devices such as the Scientific Atlanta Explorer 8000HD, and the Motorola BMC9000 Series digital cable set-top High-Definition (HD) PVRs and the Dish Network/Echostar Dishplayer DVR 921 digital satellite HD PVR. These devices are designed to drive HD displays. These devices bear similarities to set-top profiles described in the Open Cable Host Device Core Functional Requirements (all profiles). They can tune standard definition (SD) analog channels as well as standard (SD) and high definition (HD) digital channels. Advanced set-tops may include PVR and DVD playback/recording capability using dedicated drives.

Advanced digital set-tops may also include support for a home network. The home network may permit other set-tops to play content that is stored on another set-top with a PVR function. The home network may also connect to PC's. Such networked, advanced set-tops and PC's may support a media file sharing protocol such as Universal Plug-and-Play (UPnP), which permits the set-top to display or play media that is stored on the PC. This includes media such as digital music, digital photos, and digital video.

Current state-of-the-art media center PCs can connect to digital set-tops to support viewing of standard definition programming on the PC. This is accomplished with a composite or Y/C connection from the video output of the set-top to the video input of the PC. Protected video content carries Macrovision™ copy protection. The PC complies with security and copy protection rules for Macrovision™ inputs and can thus record and/or display this standard definition content.

It would be highly desirable to have a media center PC system for viewing high definition content from a digital cable or satellite set-top on a PC.

The current state of the art does not support the efficient integration of digital set-tops and Media Center PCs. For example the compressed video bit stream (usually MPEG2) received inside the set-top box is not sent directly to the PC. Instead, this compressed bit stream is first converted into an uncompressed analog signal with Macrovision™ in the set-top. This analog signal is then input into the PC where it is recompressed before storage on the PC's hard drive. This approach is expensive and gives a lower video quality due to extra hardware to perform analog-to-digital conversion and recompression steps.

It would be highly desirable to have more efficient integrated media center design, in which the original compressed video could be stored directly to a hard drive.

The current state-of-the-art PC cannot be certified according the compliance rules of Cable Labs DFAST and PHILA/CITILA license agreements, as well as the DTLA 5C DTCP license agreement. This is because the open architecture PC with its user accessible buses such as the PCI bus and AGP bus, which allow transmission and access to un-encrypted content, violate security and content protection rules (“security rules”). The open architecture PC also permits users to install any software application. This violates security and content protection rules that permit only controlled certified software to be installed in the compliant receivers for controlled content media. For example the Open Cable specifications for set-tops running OCAP contain requirements for ensuring that only certified software applications can be installed and run on such set-tops. The current state of the art PC clearly violates such requirements by permitting the installation of virtually any software.

The user accessible buses of the PC such as the PCI bus enable the user to install peer-to-peer devices that can snoop system memory and graphics frame buffers to steal either secrets and/or content. For example, in current state-of-the-art media center PCs, unencrypted uncompressed video is loaded into the PC's graphics frame buffer in order to be output to a display. Once in the frame buffer the video content is vulnerable to unauthorized copying by a peer-to-peer device. The PC is also vulnerable to attacks on other portions of the video-processing pipeline. The current state of the art for PC's uses software obfuscation techniques in an attempt to protect cryptographic keys and compressed video data. Sophisticated hackers have been able to crack such software protection mechanisms and then distribute their hacks to ordinary users over the Internet.

The activities of hackers is greatly facilitated by the openness of the PC architecture, whose specifications are widely published, and in which any desired hardware or software may be installed. “Protected” programs running on a PC can be snooped and copied while running in main memory using peer-to-peer devices. Widely available software emulators of the host processor can easily defeat anti-debug protection mechanisms. The vast majority of commercially important PC software applications have been cracked. This includes software DVD players, games, Microsoft DRM (Digital Rights Management), Microsoft Xbox, and professional applications such as AutoCAD. Windows XP, the currently shipping version of Windows has built in protection to force users to register in order to combat piracy. Hackers have been able to defeat this feature even before Windows XP shipped.

Microsoft and Intel recognize this problem and are developing a new generation of hardware and software to create a secure PC platform. The plan is to incorporate these features into the next generation of Windows code named Longhorn. Longhorn will include a secure component known as the Next Generation Secure Computing Base or NGSCB. The first release of NGSCB may not enable a fully capable protected video-processing pipeline. This secure PC platform will require a new PC incorporating all new hardware and software, which can have disadvantages in terms of cost of equipment, compatibility with existing software and hardware.

It would be highly desirable to have integrated media center design, which would not require redesigned hardware and software for PCs in order to implement an integrated media center capable of using a PC's storage systems for handling controlled content media.

Other existing state-of-the-art systems use an X86 type processor in the same system as the set-top processor. In these systems the X86 graphics data is also sent to the set-top frame buffer for compositing. Examples of such systems include the Motorola BMC9000 Series and the Intel Advanced Digital Set-top (DSTB) Platform based on the 82835 Graphics Memory Controller Hub (GMCH) plus Media Co-processor. The X86 processors in these systems are not standard PCs. They run an embedded OS such as Linux. They do not run a current version of Microsoft Windows such as Windows XP. They incorporate protection mechanisms to prevent the installation of unauthorized software. They do not have any user accessible buses such as PCI or AGP. In other words, the X86 based systems are NOT open architecture PCs and cannot provide the benefits of an integrated media center PC such as being able to run a wide range of user selectable software and PC peripherals. The X86 graphics is sent to the set-top frame buffer for compositing because the low-cost X86 graphics do not output all HD formats nor do they support HD video inputs, which would be required if set-top video were input to the x86 graphics frame buffer.

While state-of-the-art set-tops and digital televisions may support a VGA input and PIP function from a PC, and are able to display a PC's Windows desktop either full screen or in a simple PIP window, they do not support a fully integrated media center user interface.

It is known in the art to embedded storage devices and directly connected storage devices such as USB hard disk drives and networked storage devices. Such systems require the ability to encrypt controlled content video on these storage devices because even if they are installed within a set-top box, they are still vulnerable to being removed and copied. However the current state of the art does not support the viewing and copy command control of such protected content under the control an unprotected platform such as an open architecture PC. Thus, such systems can not provide a fully integrated media center user interface.

Thus, it would be highly desirable to have integrated media center system which permits the viewing, storage, and copy management of protected content on a PC's storage device in the context, of a full-featured Integrated Media Center.

Accordingly, it remains highly desirable to have method and system to over come some of the disadvantages of prior art media centers.

### SUMMARY OF THE INVENTION

It is consequently an object of the present invention to provide improvements over prior art media centers and methods for processing controlled content media.

Accordingly, an aspect of the present invention provides a method for processing a controlled-content media file on a secure system. The file has copy status information. The method has steps of receiving the controlled-content media file; checking the copy status information to ensure permission to copy; storing a local record having said copy status information, in the secure system; encrypting the controlled content media file and said copy status information; and storing the encrypted controlled-content media file and said copy status information on an unsecure storage device.

This aspect of the present invention has advantages of keeping a copy of the copy status information on a secure device to verify the integrity of the encrypted content, which addresses the disk cloning problem for devices which permit move operations for “copy once” controlled content media files.

Another aspect of the present invention provides for retrieving and displaying the encrypted file. Thus, the method has further steps of: receiving the encrypted controlled-content media file and the copy status information from the unsecure storage device; decrypting the encrypted controlled-content media file and the copy status information from the unsecure storage device; comparing copy status information from the unsecure storage device with copy status information from the local record; displaying the controlled-content media on a display device if the copy status information from the unsecure storage device matches the copy status information from said local record.

In some embodiments, the step of storing a local record is preceded by a step of encrypting the local record; and the step of retrieving the local record further comprises the step of decrypting the local record.

These embodiments have the advantage of securely storing the copy status of the copy status information within the secure device.

In other embodiments, the steps of encrypting and decrypting the controlled-content media file use an encryption key unique to said media file. The encryption key unique to the media file is stored in the local record which is encrypted with an encryption key unique to the secure system.

The advantage of these embodiments is that each media file has a different encryption key so that even if an encryption key for one media is compromised, other media files remain secure.

In some embodiments of the present invention, the local record further comprises a first record digest calculated using contents of the local record; and the step of decrypting the local record further comprises steps of calculating a second record digest using contents of the retrieved local record; and comparing the first record digest with the second record digest to ensure integrity of said local record.

In yet other embodiments of the present invention include further steps of generating a unique record ID for the controlled-content media file; and identifying the local record and the stored encrypted controlled-content media file using the record ID.

Another aspect of the present invention provides steps moving controlled-content previously stored on one unsecure storage device to another unsecure storage device. The method has steps of receiving the encrypted controlled-content media file and the copy status information from the unsecure storage device; checking to ensure a second unsecure storage device is authorized for a move operation; retrieving the local record corresponding to the controlled-content media file, and if no local record exists, then aborting operation, otherwise, decrypting the encrypted controlled-content media file and the copy status information from the unsecure storage device; checking the decrypted copy status information from the unsecure storage device to ensure a move operation is permitted; updating copy status information of said controlled-content media; storing a new local record comprising the updated copy status information, in the secure system; newly encrypting the controlled content media file and the updated copy status information; storing the newly encrypted controlled-content media file and the updated copy status information on the second unsecure storage device; deleting the first mentioned local record from the secure system; deleting the first mentioned encrypted controlled-content media file from the first mentioned unsecure storage device.

This aspect of the present invention has advantages which include protection against move operations of controlled-content media from unauthorized cloned copies of unsecure storage devices.

In another aspect of the present invention provides a set-top media system for combining with a personal computer (PC) to provide an integrated media center. The set-top media system comprises: a receiver for receiving controlled-content media from a media content provider; an output port for transmitting a video signal to a video display; and a bidirectional digital connection to the PC. The set-top media system is adapted: to receive a video signal of a PC graphical user interface (GUI) from the PC, wherein the GUI includes a window appearing to display the controlled-content media; to receive a message from said PC defining the size and location of said window within said GUI; to overlay over the GUI, a scaled video window of the controlled-content media having the defined size and location; to transmit the resulting video signal to said output port for display on said video display.

This aspect of the present invention has the advantages of being connectable to a PC to provide an integrated media center with a seamless user interface but which isolates controlled-content video from the open architecture of the PC.

In some embodiments of the present invention, the set-top media system is further adapted to connect to an unsecure storage device for storing controlled-content media. These embodiments have the advantage of providing expandable storage for media files including controlled content media.

### BRIEF DESCRIPTION OF THE DRAWINGS

Further features and advantages of the present invention will become apparent from the following detailed description, taken in combination with the appended drawings, in which:

FIG. 1 illustrates the set-top system of the present invention in a tightly coupled configuration;

FIG. 2 illustrates the set-top system of the present invention in a loosely coupled configuration;

FIG. 3 illustrates the set-top system of the present invention in a stand-alone configuration;

FIG. 4 is a block diagram illustrating the main components of the set-top system of the present invention;

FIG. 5 illustrates the video processing pipeline or a tightly coupled configuration;

FIG. 6 illustrates a HDTV screen selectable between set-top control and PC control;

FIG. 7 illustrates a HDTV screen under set-top control with set-top video full-screen and with PC screen as picture-in-picture; and

FIG. 8 illustrates a HDTV screen under PC control with a PC Desktop full-screen and with set-top video in a window;

FIG. 9 illustrates a remote sound system for the loosely coupled mode;

FIG. 10 is a flowchart of the method of storing a controlled-content media file on an unsecure storage device; and

FIG. 11 is a flowchart of the method of retrieving a controlled-content media file from an unsecure storage device.

It will be noted that, throughout the appended drawings, like features are identified by like reference numerals.

### DETAILED DESCRIPTION OF THE PREFERRED EMBODIMENT

The present invention provides a set-top media system adapted to create an integrated media center system when combined with a PC. The resulting integrated media center comprises a set-top media system and a PC system. Each system is capable of functioning independently. For the PC system an ordinary off-the-shelf PC can be used provided it meets certain minimum system requirements. Software is installed on the PC to provide integration and control functionality.

The set-top system or set-top media system of the present invention, provides all the capabilities of a digital television High Definition set-top box, and is designed to connect to an ordinary PC to create a integrated media center entertainment platform. The set-top system is a digital television set-top conforming to either the Open Cable Core Functional Requirements specification; Unidirectional Plug and Play Agreement; specifications for Direct Broadcast Satellite (DBS) services such as DirecTV or Echostar; or equivalent international standards for digital television set-tops.

The set-top system and PC may be connected in three basic configurations.

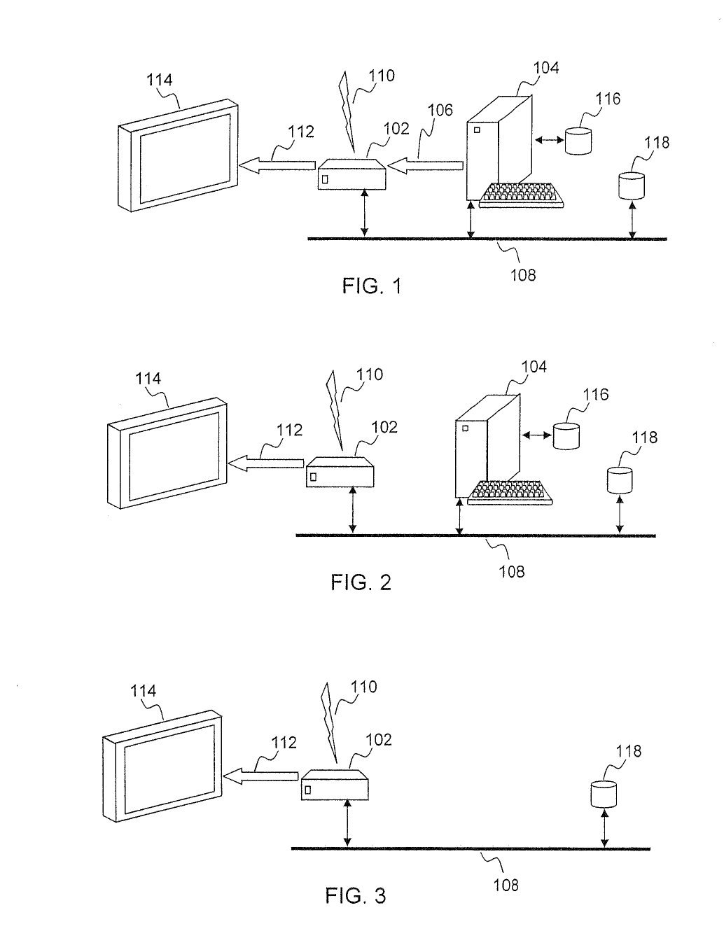

FIG. 1 shows a “tightly coupled” configuration. The set-top system 102 of the present invention and the PC 104 are placed in close proximity to each other to produce an integrated media center. The PC's graphics output is connected to the set-top 102 via a VGA or DVI connection 106. The set-top 102 and. PC 104 also share a high-speed digital link 108 such as Ethernet LAN, USB, or IEEE 1394 (FireWire). The video output from the set-top 102 is connected to a high definition display 114 via a VGA or DVI connection 112. For controlled content, if conection 112 is DVI, it supports High Bandwidth Digital Content Protection (HDCP). The set-top receives cable or satellite signals 110 which can include standard definition (SD) analog or digital and high definition (HD) video programming from a Multichannel Video Program Distributor (MVPD) such as a cable or satellite company. The set-top can store and retrieve media files from external unsecure storage devices such as a hard disk drive 116 connected to the PC 104 or a separate hard disk drive 118 connected to the set-top 102 via high-speed digital link 108.

FIG. 2 shows a “loosely coupled” configuration which also produces an integrated media center (102+104). This configuration is similar to the tightly coupled mode of FIG. 1, except that the set-top 102 and PC 104 are connected only via high-speed digital link 108 such as Ethernet LAN, USB, or IEEE1394 (FireWire). There is no connection made from the PC's graphics output to the set-top system of the present invention. Graphics output from the PC 104 is transmitted to the set-top 102 via the high speed link 108. This configuration provides less graphics performance than the configuration of FIG. 1 but greatly increases flexibility.

FIG. 3 shows a “stand alone” configuration. There is no PC in this configuration. The set-top system 102 functions as a traditional digital television set top box but with the flexibility to easily use an external unsecure storage device 118 for storing and retrieving media files including controlled-content media files.

The capabilities of the set-top system 102 will depend on the configuration. The tightly and loosely coupled configurations add additional features to the stand-alone configuration. If the PC 104 is turned off or crashes, the stand-alone features of the set-top system 102 of the present invention will still function. The set-top system of the present invention can be used in any room including the den or the living room home theatre. It can support a variety of displays including desktop VGA or HD monitors (see supported resolutions) as well as large home theatre HDTV display monitors.

The integrated media center combines all the entertainment resources of a full featured digital TV set-top including analog and digital, standard and high definition programming, and digital PVR, with those of an advanced Media Center PC including Internet access, CD and DVD player/recorder, digital music jukebox, PC based gaming, digital photography, and home video library, home security, and home automation in one inclusive platform.

The integrated media center also implements an advanced integrated home network in which other PC's and compatible set-tops can share and transfer content and data. The integrated network supports both PC and set-top media file sharing on the same network. PCs can share an Internet connection, files, and peripherals. Set-tops such as the set-top media system of the present invention supporting the DTCP-IP protocol can share PVR files in which any set-top can play back either protected or unprotected content from any set-top PVR. “Copy free” content on set-top PVR's can be shared with PC's on the Integrated Network.

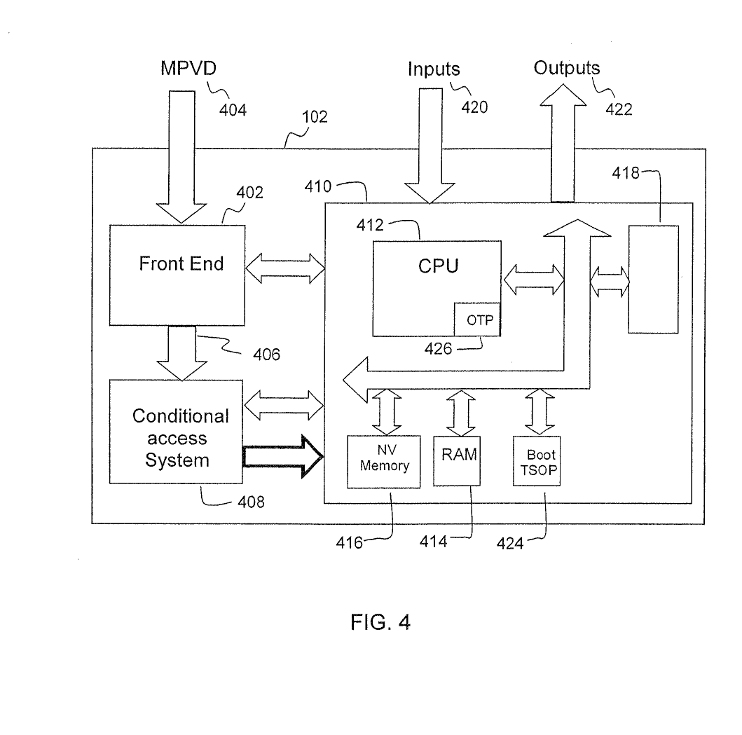

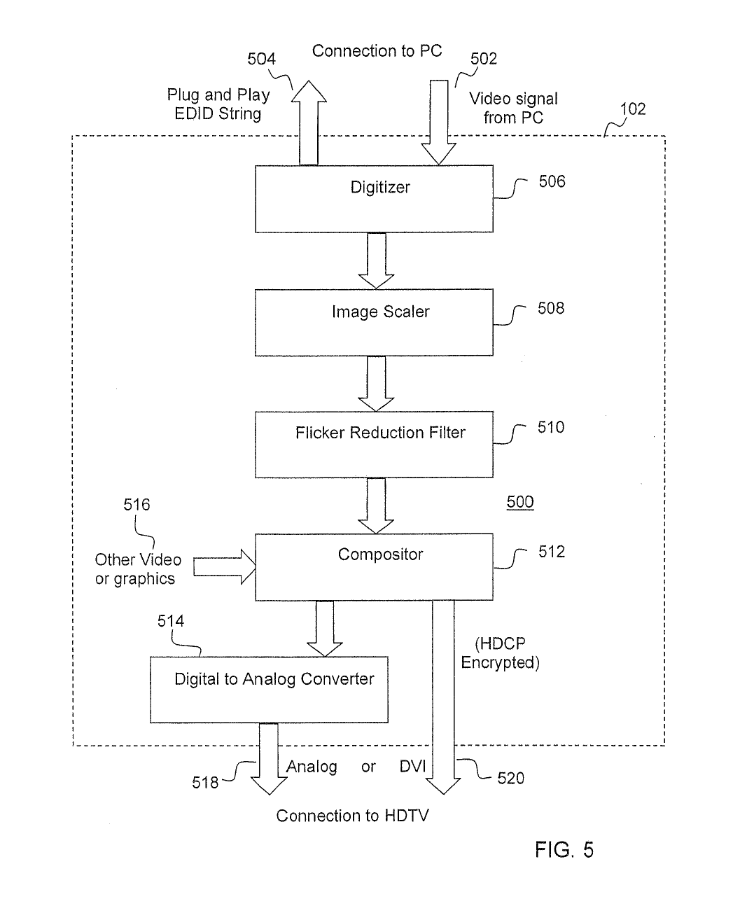

FIG. 4 shows the main components of the set-top system 102 of the present invention. The front end 402 tunes and demodulates the signal coming from the MPVD 404 to produce a transport stream 406 which is routed to the conditional access system 408. The conditional access system 408 will decrypt only the content which the user is entitled to view and route the transport stream to the processing subsystem 410. The processing subsystem 410 consists of a CPU 412, volatile memory 414 and non-volatile memory 416, and a number of peripherals 418. The transport stream may be processed e.g. scaled, de-interlaced, composed with other video sources or graphics from inputs 420, etc, and displayed on a display connected to one of the outputs 422. All processing done by the processing subsystem 410 may be accomplished through software stored in the Boot memory 424 thin small outline package (TSOP) or by a combination of software and special purpose hardware peripherals 418 such as a hardware video scaler.

Because the processing subsystem 410 of the set-top 102 can function as a general purpose computing platform, additional applications can be written to extend the functionality of the set-top 102 beyond those of a traditional digital television set top box. It is understood that these additional applications must also meet all conformance requirements.

In the preferred embodiment, the set-top media system of the present invention conforms to the profile for an advanced high definition set-top box as defined in the Open Cable Core Functional Requirements document and similar specifications for other digital cable or DBS set-tops. It fully meets all conformance requirements including all those related to security and robustness rules and design guidelines (“security rules”) to prevent theft of service and unauthorized use and copying of protected content.

The preferred embodiment of the set-top media system of the present invention implements the following design guidelines to meet security and robustness rules. There are no user accessible buses. Secrets including all cryptographic keys are encrypted using recognized encryption algorithms such as DES, triple DES, and AES encryption. Root encryption key (box key) of the set-top system is stored in a secure tamper-resistant memory such as a one time programmable (OTP) register 426 embedded in the silicon of the main processor (CPU 412) or in a technological protection measure (TPM) device. This box key is unique to each set-top device. Set-top firmware is encrypted in a thin small outline package (“boot TSOP”) 424. Set-top firmware is written using software obfuscation techniques to deter reverse engineering of the software after it has been decrypted and loaded in system memory. The boot TSOP software contains a checksum that is signed and encrypted with the box key.

Any new software installed in the set-top is encrypted and must contain a signed certificate from a trusted source before the software is installed in the system. All protected content is stored encrypted with the box key so only the originating set-top can decrypt and process such content. Typical applications include the EPG, IPPV, VOD, and PVR applications and functions. A digital cable set-top supports either the Open Cable Application Platform (OCAP) specification, or the MHP specification on the set-top system. It supports downloadable OCAP or MHP applications from Multi System Operators (MSO) such as cable companies, as well as native set-top system applications. Such OCAP or MHP applications must adhere the respective specifications for the secure download of such applications. Other digital cable and Direct Broadcast Satellite (DBS) set-tops support the corresponding middleware of the service provider. Core control firmware such as OCAP or MHP middleware can be updated via downloads to the set-top via the companion PC's Internet connection. Such middleware is encrypted and must contain a signed certificate from a trusted source (the manufacturer) before the new firmware is installed in the system. Data updates such as updates to the Electronic Program Guide (EPG), available Impulse Pay per View (IPPV) movies, and Video on Demand (VOD) content is provided to the set-top via the cable or satellite tuner data channel. The tuneris part of the front end within the set-top supports all channels and modulation formats offered by the MPVD whether over cable or DBS satellite including SD and HD digital channels as well as over the air analog and digital channels. The set-top media system supports a dual channel MPVD tuner for picture in picture, record one program while watching another, or recording two different programs simultaneously and implements the required software and hardware to support Impulse PPV (IPPV), and Video On Demand (VOD).

A personal video recorder (PVR) function simultaneously records and plays back video programs from selected sources to a hard drive or other storage device. The hard drive or other storage device may be connected directly to the set-top via the USB port in stand-alone mode, or via a networked PC drive using a digital high-speed link in the coupled modes. The PVR has the capacity to record one source, while playing back the same or different program at the same time. The PVR supports multiple recording sources including: Analog over the air (OTA) tuner if this is included in the set-top. Digital OTA tuner if this is included in the set-top. Analog cable channels in the case of digital cable set-tops. Digital MPVD delivered cable or DBS satellite channels both SD and RD. It accepts Composite, and Y/C video inputs (SD only).

Any protected content such as “copy once”, “copy no more”, or “copy never” (time shift only) material shall be stored with the copy status bits on the storage device with 3DES/AES encryption using a key (box key) that is unique to each set-top. This is to prevent unauthorized copying or playing protected content on any device other than the original set-top from which it was recorded.

Each set-top connected to a home network can play back content stored on another set-top PVR. The DTCP-IP protocol is used to establish a secure network transmission channel between the source set-top PVR and the sink set-top. This feature permits programs recorded on any set-top PVR to be viewed on any network-connected set-top in the home.

Software running on the set-top and the companion PC enables the user to make copies of content and manages copy rights as specified by the CCI copy control bits for content marked “copy free”, “copy once”, “copy no more”, and “copy never”. Copies made to any storage peripheral connected to the PC are managed according to these rights. All digital certificates, cryptographic keys, and rights management control software shall be stored and executed solely under the secure control of the set-top.

The integrated media center with the set-top system of the present invention can be a source or sink device to transfer copies to and from other DTCP licensed devices.

Picture in Picture (PIP) function supports viewing of a second channel in a window while the primary channel is displayed full screen. The PIP can also be used to view that PC's Windows display within a window while the primary video channel or other set-top application such as an EPG is displayed full screen.

The preferred embodiment of the present invention also includes features found on state-of-the-art set-top devices. Their implementation on the set-top media system of the present invention is well known to those skilled in the art.

Other features include High quality de-interlacing, 3:2 pull down, scaling, and noise reduction from any of the video sources. Cable/Antenna input accepts a type “F” connector. Other inputs accept analog video composite, and Y/C. Audio inputs accept analog L/R stereo.

The set-top media system accepts VGA/DVI input for PC graphics, supporting input resolutions: 1024×768 at 60 Hz and 1280×720 at 60Hz. Higher resolutions are also possible depending on the particular hardware implementation

Audio/Video Outputs of the set-top media system include HD analog component or VGA RGB output, HD DVI with HDCP. The DVI connector also supports VGA RGB. A mechanical adapter converts DVI to FID15. Supported HD output resolutions include: 480p, 720p, and 1080i. Optional VGA output includes 1024×768 at 60 Hz. Higher resolutions are also possible depending on the particular hardware implementation. The preferred embodiment supports 4:3 and 16:9 aspect ratios. It also supports various image scaling, stretching, and cropping formats to permit the user to choose the best fit the original image to the screen. Simultaneous composite and Y/C SD output when HD output is active. This can be used for recording to a standard VCR. The SD output supports Macrovision copy protection when required. The audio output supports: L/R analog stereo and optical SP/DIF.

The preferred embodiment of the present invention supports several network and bidirectional connections such as: IEEE 1394 with 5C DTCP for DVHS recorder or other 5C DTCP compatible recording device or HD monitor. The system supports copying and transfer of content to compatible devices in accordance with 5C DTCP; USB 1.1/2.0 for external hard drive or PC interconnect using proprietary communication and encryption protocol. Implementation techniques for such protocols are well known in the art. It also supports DTCP-USB. The system supports copying and transfer of content to compatible devices in accordance with DTCP-USB; LAN 10/100 Ethernet for PC interconnect or home network using proprietary communication and encryption protocol. Implementation techniques for such protocols are well known in the art. The system also supports DTCP-IP. It supports copying, transfer, or viewing of content to compatible devices in accordance with DTCP-IP

The preferred embodiment of the present invention supports Cable Card/Smart card slot for conditional access. The implementation the Cable Card/Smart card is well known in the art.

The present invention comes with a universal infrared remote control for controlling the main set-top and Media Center PC functions, Optionally, an infrared remote keyboard/mouse combo can be provided for full PC control.

Remote control “focus” can be set to either the set-top or PC. The remote includes buttons to directly access certain functions such as set-top TV, Guide, My Music, My Pictures, DVD, etc.

The PC runs Microsoft Windows XP Media Center Edition or equivalent and supports all the major functions of the Media PC platform including: “My TV” which includes channel selection and PVR, “Guide” (TV listings), “My Music”, “My Pictures”, “My Videos”, “Play DVD”, or “Create DVD”. The PC system hardware is standard off the shelf. A description of system requirements is included below. The PC Media Center S/W may include an electronic program guide (EPG), which is updated from an Internet connection. The PC's EPG can be used for channel selection and PVR program event recording when the remote control is set for “PC” focus. The PC's CD and DVD player can play standard DVD material including MPEG2, as well as MPEG4 content, Microsoft Windows Media 9 content including HD content, as well as all CD formats including standard CD's, MP3, WMA, and Digital Photo (JPEG). It can play all types of discs including DVD, DVD-R, DVD+R, DVD-R/W, DVD+R/W, DVD-RAM, CD, CD-R, and CD-R/W. The PC can support a full featured DVD and CD player including all “trick modes” such as skip, pause, slow motion forward and reverse, fast forward, and reverse, search forward and reverse, instant replay, jump to scene, etc. It can optionally support 3:2 pull down progressive scan.

The PC's DVD recorder can record standard DVD compatible MPEG2, as well as MPEG4 or Windows Media 9 SD and HD. Material recorded using the PVR function can be copied or transferred to DVD on the PC's DVD R/W drive. If it is “Copy Free” as specified by CCI bits, it is recorded unencrypted. Protected content including “Copy Once”, “Copy No More” material can be copied or moved to DVD with 3DES/AES encryption using the “box key”. Note that standard definition digital content is recorded directly without transcoding. This preserves the original picture quality. HD content can also be recorded directly to DVD. HD content that is “copy free” can be recompressed using a more efficient high compression codec such as MPEG4 or Windows Media 9. Such codec's can be implemented in PC software.

Some typical PC features include: CD and DVD burner to record and/or duplicate CDs or DVDs; USB 1.1/2.0 ports for digital cameras, color printers. USB can also be used to connect to a set-top media system of the present invention; 10/100 Ethernet port for Internet connectivity, home network gateway, home network connectivity or connection to a set-top media system of the present invention.

Microsoft Internet Explorer 6.0 full Internet browser provides full access to all the capabilities of the World Wide Web. It also includes access to web TV, web video content, and web Radio.

The PVR acts as a video server for the home. Playback content from any networked PC or compatible set-top is supported. “Copy free” content can be played on any device. Copy protected controlled-content can only be played on a DTCP-IP device.

The PC can support the UPnP network protocol standard. This permits media content such as digital music and photos to be shared over a home network. A PC can optionally support gaming on Widescreen HDTV with True 5.1 Surround Sound.

Recommended PC hardware is specified for different levels of capability. Two PC configurations are specified minimum and recommended:
CPU speed: minimum 500 Mhz, recommended 2.4 Ghz P4 or greater.
Memory: minimum 128 MB RAM, recommended 512 MB.
Graphics: Minimum system uses integrated graphics: Intel, VIA, or SiS. Recommended integrated graphics: ATi 9100IGP or NVidia Nforce2. Highly recommended: DX9 graphics ATi 9800, NVidia 5900.
Optical Drive: minimum system CDROM, recommended DVDROM or DVDROM plus CD/RW, highly recommended DVD R/W.
Hard Drive: minimum single 40 GB, highly recommended second hard drive 120 GB or larger.
Sound chip: minimum integrated AC97, or low cost. Highly recommended: surround sound with SPDIF or optical AC-3 output.
I/O connections: minimum USB 1.1, 10/100 Ethernet, highly recommended USB 2.0, IEEE1394.

A PC is multifunctional can can support a wide variety of activities. Some PC functions available are:
3D Games in HD format on widescreen TV with 5.1 Surround.
Internet Explorer 6.0
Internet games
Web TV: access to web sites pertaining to programming and/or advertised products.
Email and Internet chat
Home network:
Internet sharing and file share information with other PC's in the home
PVR media sharing with other PC's and compatible set-tops in accordance with DTCP-IP.
UPnP protocol support for sharing media such as digital photos and music.
Music jukebox: CD and MP3 files
Photo library, slide show presentation
Video library with thumbnails
Video editing: home movies.
Home security:
Control and monitoring of home security system.
Remote IP based video cameras for front door viewing, baby's room, etc.
Home automation system: control and monitoring of home automation system.

Internet connection can be established either through an optional DOCSIS 2.0 compatible cable modem in the set-top, or through an existing cable or DSL modem and/or home network.

The integrated media center provided by combining the set-top media system of the present invention with a PC allows the set-top and the PC to share a common high definition display. This can be an HDTV monitor or VGA type PC monitor supporting either RGB, analog component or DVI with HDCP. The common display is driven by the output of the set-top system.

In prior art media center PCs, video content such as a television channel is sent to the PC's graphics controller to be combined with the PC's graphics in the PC's frame buffer. This content cannot be high definition digital video content originating from a digital cable or digital satellite tuner, because this would violate a key content protection rule. This is because a peer-to-peer device could easily copy video content that is present in the PC's graphics frame buffer.

In the set-top of the present invention, the PC's graphics output is sent to a secure frame buffer in the set-top to be combined with video from the set-top, and transmitted to the common display. Because protected video content is never sent to the PC, there is no security violation as there would be if the architecture of prior art media center PCs were used.

The set-top system contains a VGA and DVI input for receiving graphics output from the PC via these same connections. This method is used in the “Tightly Coupled Mode”. The tightly coupled mode enables all PC graphics applications to run at full speed with all features enabled. A number of important PC applications require high performance graphics including games, graphically accelerated video playback, and certain Internet content such as “Flash” files.

FIG. 5 shows the video processing pipeline 500 for the tightly coupled configuration. The output 502 of the PC's graphics card is connected to the set-top system 102 which transmits an EDID string 504 back to the PC's graphics card. To the graphics card, the set-top system 102 appears to be a plug and play monitor.

Live video 502 is transmitted to the set-top system 102 where it is digitized and captured as a series of video frames by digitizer 506. At this point the live video stream can be scaled to the correct dimensions for display by image scaler 508. After being scaled the live video stream passes through a low pass digital filter 510 so that it appears free of flicker if displayed in an interlaced mode. The live video stream may then be composited at compositor 512 with other video streams 516 or with graphics generated by the set-top system's processing subsystem.

The live video stream is ready for display. If the set-top system is connected to a display device via an analog connection 518, the processed live video stream is converted to an analog signal by digital-to-analog converter 514 and transmitted. If the live video stream is connected to a display device via a digital (DVI) connection 520, the stream is first encrypted using the HDCP algorithm before being transmitted as a digital signal.

Each stage in the pipeline can be implemented as software running in the set-top's processing subsystem or as a combination of software running in the processing subsystem with one or more hardware peripherals helping to accelerate the processing. For example, one of the hardware peripherals in the processing subsystem could be an image scaler capable of scaling each digitized frame of the live video stream.

The PC graphics data can also be sent to the set-top system over a high-speed digital link such as Ethernet LAN, USB, or IEEE 1394 using a software method such as Virtual Network Computing (VNC). VNC is freely available software comprising two components: a server which runs on the PC 104 and a client which runs on the set-top system 102.

The function of the VNC server is to transmit the contents of the PC's graphics frame buffer over a high speed digital link to the VNC client running on the set-top system. The VNC client then reproduces the contents of the PC's frame buffer by drawing into the set-top system's frame buffer. The process is made more efficient through a number of techniques such as compressing the data being sent over the high speed link and by sending only those parts of the frame buffer that have changed.

Pre-compiled, ready-to-run versions of the VNC server are freely available for PCs running the Windows XP operating system. They can be used as is. However, in general the VNC client must be adapted to the specific platform on which it is running. In this case, the VNC client must be adapted to run on the CPU and operating system in the set-top system. In addition, the VNC client should be adapted to take advantage of any peripherals in the processing subsystem which will accelerate the VNC client, for example, a graphics accelerator.

VNC is one method by which the PC's Windows desktop is reproduced in the set-top system frame buffer. Other methods include Microsoft's Remote Desktop Protocol (RDP). These remote desktop methods are used in “Loosely Coupled Mode”. This mode can be used if the PC is located remotely from the set-top, such as in another room. It is much more limited in performance than the tightly coupled mode, since it requires the set-top graphics engine to reproduce the PC's Windows display. The set-top graphics engine is much lower performance than that available in most PCs.

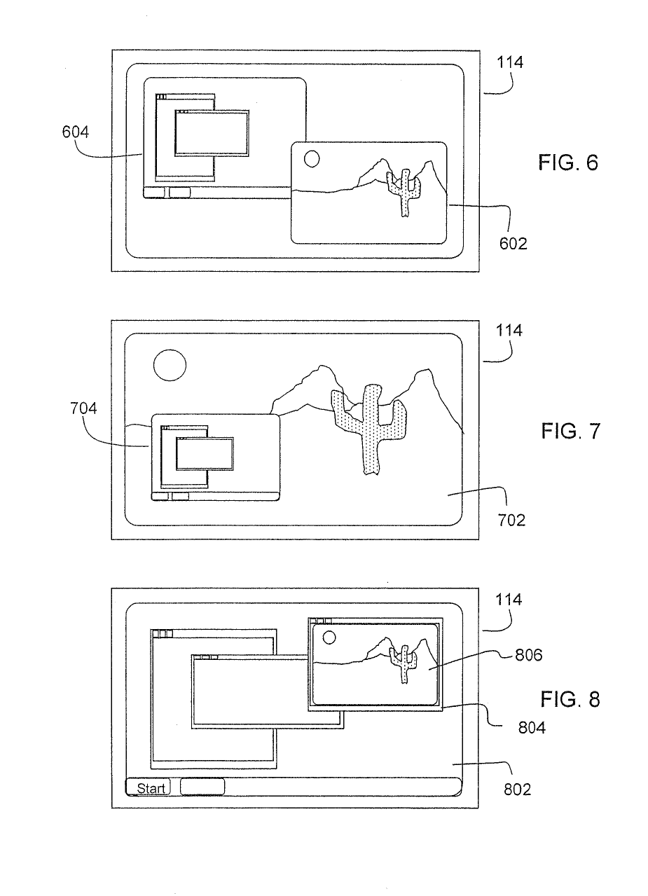

Firmware in the set-top system creates a variety of user interface screens. In the arrangement of FIG. 6, the HDTV 114 displays the set-top video in a window 602; the PC's Windows desktop is displayed in a second window 604. The user can “toggle” control between these two windows.

In the arrangement of FIG. 7, the HDTV 114 displays the set-top video full screen 702. This can be the primary video channel and/or any set-top GUI such as an OCAP electronic program guide (EPG) application. The set-top supports “picture in picture (PIP)” The PC's Windows desktop can be shown in a PIP window 704 in the same manner as a second video channel.

In a third arrangement, illustrated in FIG. 8, the shared HDTV 114 is under PC control. The PC's Windows desktop 802 is displayed full-screen. The user interface permits opening a resizable “TV viewer” window 804 on the PC's desktop 802. The position of the scaled video window is controlled by the PC Windows application in a manner that looks identical to current state-of-the-art media center systems where the PC controls the screen. In this case however, the PC opens a blank window 802 and a driver at the graphical device interface (GDI) level intercepts calls for the creation of video overlay surfaces. The interception or “hooking” of drivers at the GDI level is a technique that is well known in the art. This information is sent to the set-top system and used by firmware in the set-top system to position a scaled video window 806 in the desired location over the PC's Windows desktop so that it appears inside the frame of the PC “TV viewer” window 804. Other information relevant to a “TV viewer” window, such as video source selection or channel number can be sent to the set-top as well. In this manner, a seamless, integrated user interface is presented to the user in which the division between the PC and set-top is hidden from the user.

There are other advantages to sending the PC's graphics display to the set-top frame buffer to be composited with protected digital video content as a part of an integrated media center PC. The protected video content remains protected since it is never sent to the PC and only a single display such as a HD display is required for both the PC and set-top systems. A direct video connection from the PC to the set-top enables the user to benefit from the full performance of the PC's graphics subsystem.

The PC and set-top system share an audio system. This can be a home theatre receiver, stereo receiver or the sound system of a television. The audio connection schemes are analogous to the video connections schemes.

When configured in the tightly coupled mode the audio output of the PC can be connected to the set-top system, or to inputs on a home theatre or stereo receiver. When connected to the set-top system while displaying the PC's desktop, the audio is passed through to the set-top system's audio outputs. When the set-top system is displaying something other than the PC's desktop, the PC's audio is disconnected from the set-top system's audio outputs.

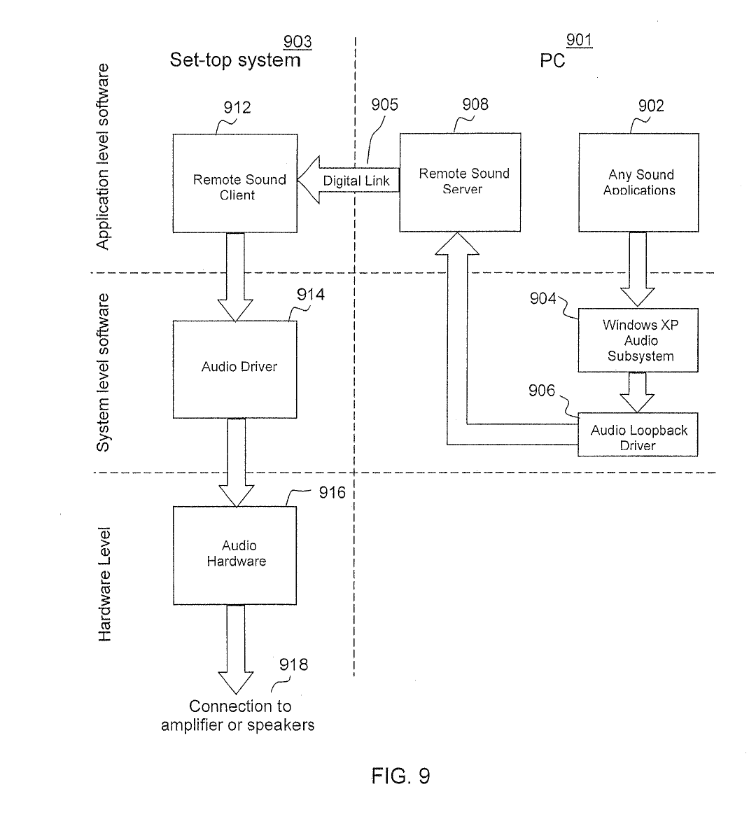

With reference to FIG. 9, when configured in the loosely coupled mode, the PC(901)'s audio is transferred to the set-top system 903 via a high speed digital link 905 by means of a “remote sound” system. The remote sound system consists of three special purpose software components. A remote sound server 908 and a remote sound audio loop-back driver 906 run on the PC. A remote sound client 912 runs on the set-top system 903. When the remote sound system is in operation, the PC's default sound card driver is replaced by the remote sound audio loop-back driver 906. All applications configured to use the PC's default sound driver will now use the audio loop back driver 906. The remote sound audio loop-back driver receives audio data from the PC's audio software subsystem 904 in PCM form. Instead of transferring this data to the PC's audio hardware, the audio data is made available to the remote sound server running on the PC.

The remote sound server encapsulates the audio data into packets suitable for transmission over a local area network 905 (or other high speed digital link) and transmits it to the remote sound client 912 running on the set-top system 903. The remote sound client 912 on the set-top system 903 then extracts the data from the packets and sends it to the set-top system's audio driver 914. The set-top system's audio driver 914 then plays the audio out through its hardware audio subsystem 916 i.e. an audio signal is generated and transmitted through the set-top system's audio connectors 918.

Both the PC and the set-top system can share all the PC's hard drive(s), DVD player/recorder, and other PC storage devices such as floppy drives, USB drives, etc. Sharing can be accomplished through standard protocols such as NFS or SMB. Software components which implement the server side for the PC and the client side for the set-top system are freely available. While pre-compiled, ready to run server components exist for the PC running Windows XP, client components may need to be adapted to run on the specific CPU and operating system of the set-top system.

In prior art media center PCs, the PC manages all storage of content whether protected or unprotected, encrypted or non-encrypted. The openness of the PC architecture with its user accessible buses, and the ability to install any software means that all current PC based digital rights management is subject to attack and fails to meet the necessary security rules.

The integrated media center using the set-top system of the present invention solves this problem by storing protected content on the PC with robust encryption such as triple DES or AES encryption. The set-top system retains all cryptographic keys and is solely responsible for digital rights management. The PC is used strictly as a “dumb bit bucket” storage device. To be decrypted and used for any purpose, the encrypted content must first be sent from the PC to the set-top system. The set-top system possesses the cryptographic keys and the software for digital rights management. The set-top system is responsible for decrypting all content and effectively controls all uses of protected content including display or transmission over authorized secure links such as 1394 with 5C DTCP or Ethernet LAN with DTCP-IP.

The set-top system and the PC are connected via high-speed digital links such as Ethernet LAN, USB, or IEEE1394. The high-speed digital link is used to transfer compressed content between the set-top system and the PC. This content is encrypted if it is protected content or unencrypted if it is “copy free”. Software running on the set-top and the PC mediate transfer and the use of the data. Typical applications include recording content from the set-top to the PC's storage device(s), playing back content from the PC's storage device(s) on the set-top, performing a PVR function where a program is being recorded and played back from the PC's storage device(s) simultaneously, and transmission of content between the PC's storage device(s) other DTLA licensed devices over secure links such as 1394 with 5C DTCP, or Ethernet LAN with DTCP-IP.

The set-top system in combination with any storage devices connected to it either directly or indirectly through a connected PC is certifiable by CableLabs and the DTLA as both a source and sink function. A Source Function means that the set-top system can encrypt and transmit original protected content either live from its built in tuner or from a connected storage device to a licensed DTCP sink device. A Sink Function means that the set-top system can receive and decrypt protected content from a licensed DTCP source device and either display this content and/or record it to a connected storage device. Software running on the set-top system and PC manages copy rights based on the so called Copy Control Information (CCI) bits for content marked “copy free”, “copy once”, “copy no more”, and “copy never”. Copies respecting these rights can be made to any storage peripheral connected to the PC as well as to external devices certified by the DTLA to 5C DTCP, DTCP-USB, or DTCP-IP.

The set-top system of the present invention meets all the “security rules” specified by CableLabs and the DTLA for 5C DTCP, DTCP-IP, and DTCP-USB. All digital certificates, cryptographic keys, and rights management control software are stored and executed solely under the secure control of the set-top system. All this information and control software is stored encrypted in the set-top system using the unique box key for each set-top system device.

“Copy free” content stored on the PC's storage device(s) can be used by a wide range of available PC software applications including video editing, DVD authoring, recompression to a more efficient compression codec such as Windows Media 9, transmission over the Internet, etc. Unlimited backup copies of “copy free” content can be made.

With appropriate software, “copy once” copies may be made on PC storage devices such as hard drives or DVD burners. “Copy no more” copies may be moved from one storage device to another. “Copy never” content cannot be copied. It is retained on a PVR storage device for a maximum of 90 minutes from the time it is recorded.

The set-top system uses the same underlying architecture to control copies on storage devices, whether they are connected directly to the set-top system or are connected directly to a PC, which is in turn connected to the set-top system via a high-speed data link. The techniques used are similar to those used on existing state of the art set-top boxes with embedded hard drives. Embedded hard drives are vulnerable to rogue user attacks since they use standard interconnects such as IDE and SATA, and standard file systems such as Linux. A rogue user could remove an embedded hard drive, connect it to an open system such as a Linux based PC, and attempt to make unauthorized copies of embedded content. Therefore a set-top with an embedded drive must incorporate mechanisms to thwart such unauthorized activities.

The set-top system is an advance over the current state of the art in that it incorporates both content protection and copy control mechanisms that work with any connected storage device, and in particular with storage devices connected to a standard PC in the context of an integrated media center application. Furthermore, software running on either the set-top or the open architecture PC can be used to view and/or to order the making of copies of protected content.

The user has unified access to all content regardless of copy protection status and whether the content came from the MPVD or from a PC source such as the Internet. Applications running on either the set-top or the open architecture PC can command the viewing, recording, or playback content whether protected or not. Applications running on either the set-top or the open architecture PC can command the making of copies, the transfer of copies and other copy management tasks whether the content is protected or not. In all cases of protected content, the set-top system will ensure that the content is protected and the management of copies is done in conformance with the CCI bits.

The techniques for content protection and copy control are similar to those used in set-tops with embedded storage. The file structure of protected content stored on a PC storage device is similar to that used on an embedded hard drive. The PC's storage device can be used to store all other types of PC files and content as well.

One particular method for managing protected content will be described here. The set-top runs a version of the Linux Operating System and File Management System. Remote drives connected to a PC are abstracted by the Linux OS as shared remote network drives. The PC is connected to the set-top via a high-speed digital link such as Ethernet LAN, USB, or 1394. The PC's storage devices are abstracted as remote shared network drives over any of these links. This permits the set-top to use standard Linux OS commands for managing files on the PC's storage devices. The same shared drives are also accessible by the PC's Windows OS. All set-top protected content recorded on a storage device including program header information is encrypted using a robust encryption method such as AES or triple DES encryption. The encryption key (box key) is unique to each set-top system device. Therefore only the original source set-top system device is able to decrypt this content for use.

A further mechanism ensures copy control over protected content. Within the file structure of each file, the following program header information is stored: a unique program identification number for each file, the copy status of each recording (“copy free”, “copy once”, “copy no more”, “copy never”), and the number of copies made. In addition, during a recording a time stamp with the current time derived from the program stream of the MVPD is recorded every minute. Within the non-volatile memory (TSOP) of the set-top system an independent record is kept of the file header information. This record includes the program identification number, the copy status, and the number of copies made. This information is encrypted with the box key on both the storage device and the internal TSOP. Each time a recorded program file is opened, the program header information from the storage device and the TSOP are compared by the set-top system. If the information is different the user is notified and the user may be denied access to the content. The PC cannot open such files without the collaboration of the set-top system because they are encrypted using the box key of the set-top system.

This mechanism is designed to make additional unauthorized copies of protected content unusable, For example, a rogue user could make clone copies of hard drives containing “copy once” material. Without this mechanism, each such hard drive could be connected in turn to the set-top system and then used to make copies to connected DTCP sink devices such as a DVHS recorder. The rogue user could use this procedure to make an unlimited number of copies. This rogue copying process is thwarted by the storage of the program header information in the TSOP. The number of copies made of a given program is stored in the TSOP. For “copy once” programs, the user is limited to two copies. Connecting another hard drive with a fresh “copy once” version of the same program will be detected. The TSOP data will detect a mismatch in the “number of copies made” field and prevent additional copies from being made.

“Copy no more” content can be moved from one storage device to another. The content must be deleted from the source device if “copy no more” content is moved to a sink device. The set-top system tracks “copy no more” content on its storage devices through its program header information. The set-top system supports moving “copy no more” content in accordance with the CableLabs and DTCP specifications. “Copy no more” content may be moved from the set-top of the present invention, to an external DTLA device such as a DVD recorder. Moving “copy no more” content in the other direction is not supported since DVD recordings cannot be deleted.

The one-minute time stamps embedded in each recording provide the necessary control for “copy never” content. Such content can be time delayed for up to 90 minutes. This popular PVR feature permits the user to “pause” a program for up to 90 minutes. After 90 minutes “copy never” content cannot be viewed. “copy never” content is recorded into a 90-minute circular buffer on the hard drive. If the current time exceeds the time stamp on the recorded program by 90 minutes, the content cannot be displayed.

Using the PC's storage devices for storing set-top content has several advantages. The use of ubiquitous PC hard disk drives lowers overall system cost. Rather than using dedicated storage devices in the set-top, which adds cost to the set-top, existing PC storage devices can be used. Once stored on the PC's storage devices, the user has a wider range of applications and options for using the content, particularly “copy free” content. The PC's storage can also be used for other purposes such as for storing My Pictures, My Audio, and various other PC applications such as games.

The same remote control device is used to control both the set-top system set-top and the PC. In the case of the state of the art Media Center, the remote control commands are first sent to the PC. Certain commands are then redirected to the set-top or TV tuner system. In the case of the set-top system, the remote control commands are first sent to the set-top. Certain commands are then redirected to the PC. The commands to the PC are sent over the high-speed digital link to the set-top. These commands are interpreted by the PC as standard PC keyboard, mouse, PC Media Center remote control, or game controller inputs.

The remote control design of the integrated media center using the set-top system of the present invention offers a number of advantages including lower cost and greater ease of use. A set-top must have a remote control as a standard feature. This is an extra cost for the PC. By using the set-top as the remote control master, a lower cost is achieved. Placing the control function in the set-top permits the development of a simple user-friendly interface that fully accesses all the unique set-top functions as well as all of the functions of the PC.

The set-top system remote control has two main modes of operation: “set-top centric” and “PC centric”. Master control buttons on the remote shift the focus of the remote between set-top control and PC control. Certain PC applications such as My Pictures, and My Audio have their own direct access control buttons.

The remote control for set-tops running custom applications such as IPPV and VOD are difficult or impractical to implement on a PC remote. Current state of the art Media Center PC's are unable to perform IPPV or VOD functions. The set-top system fully supports these features while in set-top centric mode. Also while in set-top centric mode, the user has the option of viewing the PC's display in a PIP window on the set-top display.

While in PC centric mode, depending on the application the user can view set-top video content in a window on the PC's Windows desktop. Also certain PC applications can send commands to the set-top system. For example a PC application can command the set-top to change channels or to enter a programming event into the PVR event-recording list.

The remote control commands originating in the set-top are sent to the PC via one of the digital high-speed links such as Ethernet LAN, USB, or 1394. The same data link is used to send commands from PC applications to the set-top system while in PC centric mode. There are thus several “channels” of communication for remote control commands depending on whether one is in a set-top or PC centric mode, and on whether an application that is the focus of control needs to send commands to either the set-top or PC system.

The following is a more detailed description of the controlled-content media management with reference to well known industry certification standards.

Under the Compliance Rules of the DFAST Technology License Agreement (“DFAST License Agreement”), various digital outputs and content protection technologies are allowed on Unidirectional Digital Cable Products (UDCPs), e.g., 1394/DTCP, DVI/HDCP, HDMI/HDCP, etc. Furthermore, under both DFAST and PHILA/CHILA, a licensed product may output Controlled Content, and pass Controlled Content to an output, in digital form where such output is protected by using DTCP.

The DTCP specification defines a cryptographic protocol for protecting audio/video entertainment content from illegal copying, intercepting and tampering as it traverses high performance digital buses, such as the IEEE 1394. DTCP has also been mapped to protect other digital transports as well, and can be mapped to protect any high-speed bi-directional transport. It has also been mapped for use over an Internet Protocol (“DTCP-IP”) for wired and wireless transports, including Ethernet and 802.11 transports, the MOST interfaces for mobile environments, and for the USB transport.

Although DTCP is a proven technology for protecting the controlled content as it traverses over high performance buses, it requires the sink device to have the intelligence for negotiating, exchanging keys and performing cryptographic functions.

Thus, it is well suited for CE devices such as a DVHS recorder and external PVR devices. But it does not provide any provision for connection to non-intelligent devices like a USB, SATA or a remotely connected hard drive.

A non-intelligent device, for example a hard disk, could be connected to any digital output port such as USB, 1394, SATA or LAN of the set-top media system of the present invention, while maintaining complete security of copy-protected content. The present invention defines a new digital output port mechanism for connecting a set-up box to non intelligent devices like an external USB hard drive, External SATA hard drive or a remotely connected hard drive i.e. a mapped hard disk on a remote PC. It provides a method in which encrypted controlled content can be outputted to these devices for the sole purpose of storage. It is important to note that the stored controlled content is encrypted and fully protected and it can only be played back on the unit from which it originated.

According to the DFAST and PHILA licenses agreement section 3.5.1 the licensed product can make a copy of Copy One Generation material where each copy of Copy One Generation is tied to the device and is marked as Copy No More. It is also stated in DFAST and PHILA license agreement that a licensed product can move Copy One Generation content in accordance with section 3.5.2 of the compliance rules. The interpretation of these sections suggests that the CCI bits are embedded within the copied controlled content thus making the controlled content vulnerable to a save/restore or hard disk cloning attack.

A save/restore or hard disk cloning attack can be defined as follows: A compliant device i.e. a set-top box with PVR functionality makes a copy of Copy One Generation Controlled Content and marks it as Copy No More to indicate that a copy has been made. A hacker makes a bit by bit copy of the hard disk containing the controlled content or in other words, he makes a clone of the hard disk. The hacker then replaces the original hard drive with the cloned hard drive and performs the move operation to transfer the controlled content from one compliant licensed product to another complaint licensed product for example, moving the content from a Personal Video Recorder (PVR) box to a DVHS recorder. The compliant device in this case the PVR moves the controlled content according to the DFAST and PHILA compliance rules, the controlled content is read from the hard drive, the embedded CCI bits are changed from Copy No More to Copy One Generation and the content is moved to another compliant device. The PVR then destroys the controlled content on its hard drive as required by the DFAST or PHILA. However, the hacker still has the original hard drive he/she can use to perform a bit by bit restore to replicate the same content on a cloned hard drive. This new cloned drive can be used again to move the same protected content to another DVHS recorder. This results in a second copy. This operation can be performed many times thus making multiple copies of Copy One Generation material.

It is important to note that this problem is not only applicable to an external connected hard drive or remotely connected hard drive. It also applies to devices that have internal hard drive like a digital PVR. A hacker can easily open the box and disconnect the hard drive and perform the disk cloning operation.

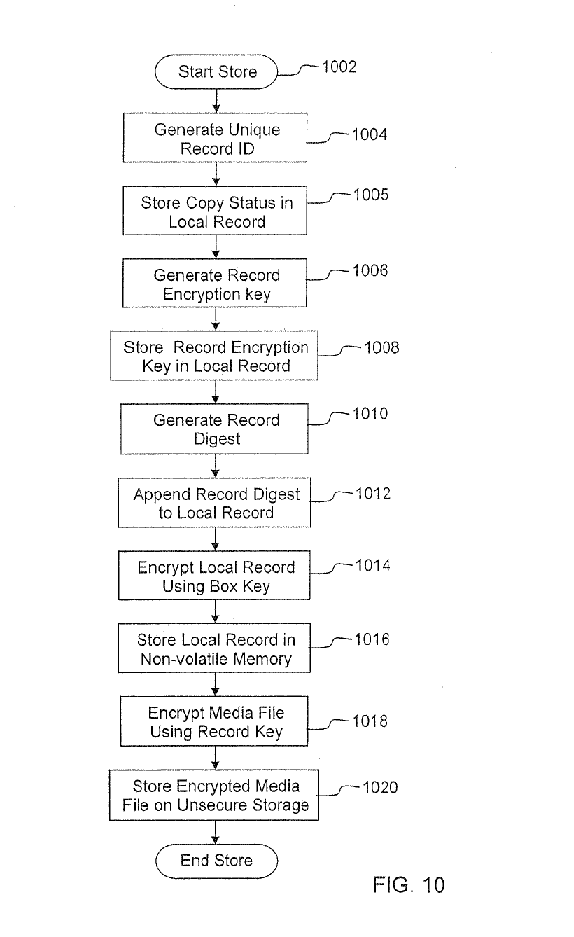

The mechanism of the present invention prevents a save/restore attack. The mechanism for storing controlled-content media on an unsecure device will be described with reference to FIG. 10, which illustrates a flow chart of the steps of the method. This attack is defeated by having the compliant Unidirectional Plug and Play or Open Cable OCAP device keep a record of the Copy One Generation program info and associated CCI bits (copy status information) 1005, in the non-volatile memory whenever a copy of the Copy One Generation content is made 1020. The CCI bits are modified according to DFAST or PHILA compliance rules. The modified CCI bits and Record Encryption key are encrypted 1014 using the set-top box unique key before being stored in non-volatile memory 1016. When a compliant device is asked to perform a move operation for a particular controlled content, it first checks within its non-volatile memory to find the record of the controlled content. If no entry is found then the compliance device will reject the move operation, otherwise the compliant device will move the content in accordance to DFAST and PHILA compliance rules. It will then destroy the controlled content related information including the associated Record Encryption key and CCI bits in the non-volatile memory thus removing any record entry of the controlled content. Therefore by removing the controlled content related information from the non-volatile memory another move for the same controlled content will fail. With this mechanism, cloned disks can be considered as “redundant” copies.

As part of the mechanism to track and manage controlled-content media, a record ID is used. The Record ID is a 64 bit unique number that will be generated in order to identify each recorded program. It will be added as part of the file name of the program stored on the hard drive in addition to being stored in the file with the encrypted controlled content. The Record ID will also be used as a search key in the database where any information needed to playback the selected recording i.e. program title, program description, etc are stored. This program specific information will also be encrypted using the Record Encryption key (Record-Kc) before being stored in the database. This Record ID in non-volatile memory will not be encrypted since it does not provide any information about the controlled content or CCI bits and it is only used as a reference number to find the proper record.

The Record Encryption Key is a unique encryption key that is generated for each controlled content (i.e. recorded Program). This parameter is encrypted using the unique secret box key

Copy Control Information (CCI) bits form an 8 bit field contains the controlled content associated Copy Control Information (copy status information). This parameter is encrypted using the unique secret box key.

A Record-Pad is a 24 bit random number will be generated in order to pad the CCI bits field on a 32 bit boundary. This parameter is encrypted using the unique secret box key.

Before encrypting 1014 each recording entry in non-volatile memory, a Record-Digest is generated 1010 and is appended 1012 at the end of each record entry in non-volatile memory. This is to guarantee the integrity of the CCI bits and encryption keys stored in non-volatile memory. The SHA-1, as described in FIPS PUB 180-2 is used to generate a Record-Digest of length 160 bits. This Record-Digest is calculated from three parameters: Record-Kc, Record-CCI bits and Record-Pad. The Record-Digest is then encrypted 1014 using the unique secret box key.

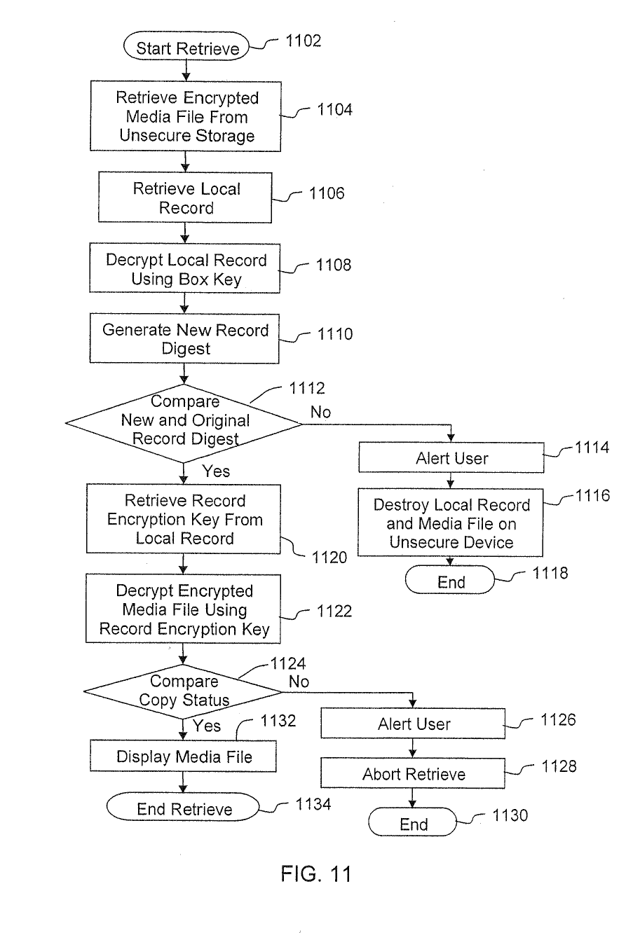

The media file retrieval method will now be described with reference to FIG. 11. When a recording entry is read from non-volatile memory 1106, the entry will be decrypted 1108 and a new Record-Digest will be generated 1110 using the decrypted parameters 1111 (i.e. CCI bits, Record-Kc, Record-Pad) and will be compared 1112 with the decrypted Record-Digest extracted from the recording entry. If the two Record-Digests match then the integrity of the recording entry is guaranteed; otherwise, this could either indicate that the recording entry has been manipulated or the entry has been corrupted. For example, a hacker could try to change the encrypted CCI bits. Since the EMI field in the CCI filed is a two bit value the hacker could have a 1 out of 4 try to change the CCI bits from Copy One Generation to Copy Free The Record-Digest eliminates this attack by guaranteeing the integrity of the parameters stored in non-volatile memory. In case of mismatch, the user is alerted 1114. The user is given the option to delete recording. The entry in the non-volatile memory, the associated controlled-content media on the external hard drive and any other related information are destroyed 1116.

The following is a list of steps used to store/retrieve an entry containing the recorded controlled content parameters to/from the non-volatile memory:
1. A Record-ID is generated for each recording;
2. A 24 bit random number Record-Pad will be generated in order to pad the CCI bits on a 32 bit boundary;
3. A 160 bit Record-Digest will be generated using the CCI bits, Record-Kc, and the 24 bit Record-Pad;
4. The 160 bit Record-Digest, Record-Kc, CCI bits, Record-Pad and Record-ID is formatted;
5. The Record-Kc, CCI bits, Record-Pad and Record-Digest are encrypted using the unique secret box key;
6. The encrypted record is stored in non-volatile memory.

The following is a list of steps used for reading a record from non-volatile memory:
1. A recording entry is read from non-volatile memory;
2. The recording entry is decrypted using the unique secret box key;
3. the CCI bits, Record-Pad and Record-Kc are extracted form the recording entry;
4. A new Record-Digest is generated using the parameters extracted in step 3
5. The Record Digest is extracted from the recording entry;
6. The Generated Record-Digest will be compared with the extracted Record-Digest;
7. In case that there is a mismatch between the generated Record-Digest and the recording entry Record-Digest, the user is notified. The user is given the option to delete the recording. In this case, recording entry in the non-volatile memory, the associated controlled content on external hard drive and any other information related to this entry will be destroyed.

The embodiments of the invention described above are intended to be exemplary only. The scope of the invention is therefore intended to be limited solely by the scope of the appended claims.

1-24. (canceled)

25. A method for processing a controlled-content media file on a secure system, said file having copy status information, the method comprising steps of:
receiving said controlled-content media file;
checking said copy status information to ensure permission to copy;
storing a local record comprising said copy status information, in said secure system;
encrypting said controlled-content media file and said copy status information; and
storing the encrypted controlled-content media file and said copy status information on an unsecure storage device.

26. A method as claimed in claim 25 further comprising steps of:
receiving said encrypted controlled-content media file and said copy status information from said unsecure storage device;
decrypting the encrypted controlled-content media file and said copy status information from said unsecure storage device;
comparing copy status information from said unsecure storage device with copy status information from said local record; and
displaying said controlled-content media on a display device if said copy status information from said unsecure storage device matches said copy status information from said local record.

27. A method as claims in claim 26,
wherein said step of storing a local record is preceded by a step of encrypting said local record; and
wherein said step of retrieving said local record further comprises step of decrypting said local record.

28. A method as claimed in claim 27 wherein said encrypting steps and decrypting steps use an encryption key unique to said secure system.

29. A method as claimed in claim 27 wherein said steps of encrypting and decrypting said controlled-content media file use an encryption key unique to said media file; and
wherein said local record further comprises said encryption key unique to said media file; and
wherein the steps of encrypting and decrypting said local record use an encryption key unique to said secure system.

30. A method as claims in claim 29 wherein said local record further comprises a first record digest calculated using contents of said local record; and
wherein said step of decrypting said local record further comprises steps of:
calculating a second record digest using contents of the retrieved local record; and
comparing said first record digest with said second record digest to ensure integrity of said local record.

31. A method as claimed in claim 29, further comprising steps of generating a unique record ID for said controlled-content media file; and
Identifying said local record and the stored encrypted controlled-content media file, using said record ID.

32. A method as claimed in claim 29 wherein said steps of encrypting use a recognized encryption algorithm selected from the group consisting of: DES; 3DES; AES.

33. A method as claimed in claim 29 wherein said controlled-content media file comprises high definition video.

34. A method as claimed in claim 33 wherein said unsecure storage device is indirectly connected to said secure system.

35. A method as claimed in claim 34 wherein said unsecure storage device is part of a PC storage system.

36. A method as claimed in claim 33 wherein said unsecure storage device comprises a hard disk drive.

37. A method as claimed in claim 33 wherein said unsecure storage device is connected directly to said secure system.

38. A method as claimed in claim 33 wherein said unsecure storage device is connected directly to said secure system.

39. A method as claimed in claim 25 further comprising steps of:
receiving said encrypted controlled-content media file and said copy status information from said unsecure storage device;
checking to ensure a second unsecure storage device is authorized for a move operation;
retrieving the local record corresponding to said controlled-content media file, and if no local record exists, then aborting operation;
decrypting the encrypted controlled-content media file from said unsecure storage device and said copy status information from said local record;
checking the decrypted copy status information from said local record to ensure a move operation is permitted;
updating copy status information of said controlled-content media;
generating a new encryption key unique to said controlled-content media file;
storing a new local record comprising the update copy status information and said new encryption key, in said secure system;
newly encrypting said controlled-content media file and said updated copy status information;
storing the newly encrypted controlled-content media file and said updated copy status information on said second unsecure storage device;
deleting the first mentioned local record from said secure system; and
deleting the first mentioned encrypted controlled-content media file from the first mentioned unsecure storage device.

40. A set-top media system for combining with a personal computer (PC) to provide an integrated media center, said set-top media system comprising;
a receiver for receiving controlled-content media from a media content provider;
an output port for transmitting a video signal to a video display; and
a bidirectional digital connection to said PC;
wherein said set-top media system is adapted to:
receive a video signal of a PC graphical user interface (GUI) from said PC, said GUI including a window appearing to display said controlled-content media;
receive a message from said PC defining the size and location of said window within said GUI;
overlay over said GUI, a scaled video window of said controlled-content media having the defined size and location;
transmit the resulting video signal to said output port for display on said video display.

41. A set-top media system as claimed in claim 40 wherein said video signal from said PC is received via said bidirectional digital connection.

42. A set-top media system as claimed in claim 40 wherein said bidirectional digital connection of a type selected from the group consisting of: network interface; USB; IEEE 1394.

43. A set-top media system as claimed in claim 40 wherein said video signal from said PC is received via a video input port.

44. A set-top media system as claims in claim 40, further adapted to connect to an unsecure storage device for storing c controlled-content media.

45. A set-top media system as claimed in claim 44, wherein said unsecure storage device can be connected remotely through said PC.

46. A set-op media system is claimed in claim 44, wherein said unsecure storage device can be connected directly, through a connection of a type selected from the group consisting of: network interface; USB, IEEE 1394.

47. A method as claimed in claim 25 further comprising the steps of:
receiving said encrypted controlled-content media file and said copy status information from said unsecure device;
checking to ensure a second secure storage device is authorized for a move operation;
retrieving the local record corresponding to said controlled-content media file, and if no local record exists, then aborting operation;
decrypting the encrypted controlled-content media file from said unsecure storage device and said copy status information from said local record;
checking the decrypted copy status information from said local record to ensure a move operation is permitted;
updating copy status information of said controlled-content media;
moving of said controlled-content media and said updated copy status information on said second secure storage device;
deleting the first mentioned local record from said secure system; and
deleting the first mentioned encrypted controlled-content media file from the first mentioned unsecure storage device.

48. A system, comprising:
a receiver configured to receive a controlled-content media file from a media provider, wherein said controlled-content media file includes a copy control information date field having at least copy status information designating copy rights associated with said controlled-content media file;
an unsecure storage device configured to be connected with said receiver; and
wherein said receiver includes an application configured and operable to:
check said copy status information to determine if said receiver has permission to copy said controlled-content media file to an unsecure storage device connected with said receiver;
generate a unique record identification for a local record to be stored on said receiver that is associated with said controlled-content media file;
store said copy status information in said local record;
generate a record encryption key that is stored in said local record;
generate a record digest using said copy status information, said record encryption key and a record pad;
append said record digest to said local record;
encrypt said local record using a unique box key associated with said receiver;
store said local record in a non-volatile memory of said receiver;
encrypt said controlled-content media file using said record encryption key to form an encrypted controlled-content media file; and
transmit said encrypted controlled-content media file to said unsecure storage device.

49. The system of claim 48, wherein said application is further configured and operable to:
retrieve said encrypted controlled-content media file from said unsecure storage device;
retrieve said local record from said non-volatile memory of said receiver;
decrypt said local record using said unique box key associated with said receiver;
generate a new record digest;
compare said new record digest with said original record digest; and
delete said local record and said encrypted controlled-content media file on said unsecure storage device if said new record digest does not match said original record digest.

50. The system of claim 49, wherein said application is further configured and operable to:
retrieve said record encryption key from said local record;
decrypt said encrypted controlled-content media file using said record encryption key;
obtain said copy status information from said encrypted controlled-content media file and said copy status information from said local record;
compare said copy status information from said encrypted controlled-content media file and said copy status information from said local record; and
generate a media transmission operable to display said controlled-content media file if said copy status information obtained from said encrypted controlled-content media file matches said copy status information obtained from said local record

51. The system of claim 50, wherein said application is further configured and operable to alert a user if said copy status information obtained from said encrypted controlled-content media file does not match said copy status information obtained from said local record.

52. The system of claim 51, wherein said application is further configured and operable to abort retrieving said encrypted controlled-content media file if said copy status information obtained from said encrypted controlled-content media file does not match said copy status information obtained from said local record.
